(19) United States
(12) Patent Application Publication
(10) Pub. No.: US 2017/0166846 A1
(43) Pub. Date: Jun. 15, 2017

(54) WATER SOLUBLE UNIT DOSE ARTICLE

(71) Applicant: The Procter & Gamble Company, Cincinnati, OH (US)

(72) Inventors: Jean-Pol BOUTIQUE, Gembloux (BE); Karel Jozef Maria DEPOOT, Anzegem-Vichte (BE); Lucia Fernandez Martinez, Brussels (BE); Nea Janette Lintula, Brussels (BE); Laura Orlandini, Le Mont sur Lausanne (CH)

(21) Appl. No.: 15/368,715

(22) Filed: Dec. 5, 2016

(30) Foreign Application Priority Data
Dec. 14, 2015 (EP) 15199721.0
Sep. 27, 2016 (EP) 16190779.5

(51) Int. Cl. C11D 17/04; C11D 11/00; C11D 3/50

(52) U.S. Cl. CPC C11D 17/045; C11D 17/044; C11D 17/043; C11D 3/505; C11D 11/0017

(57) ABSTRACT

A multi-compartment water-soluble unit dose article that includes a water-soluble film, where a first compartment includes a powder composition and a second compartment includes a liquid composition, and where the powder composition includes perfume microcapsules.

### FIELD OF THE INVENTION

The present disclosure relates to multi-compartment unit dose articles and methods of using thereof.

### BACKGROUND OF THE INVENTION

Multi-compartment unit dose articles are known in the art. Such articles are usually constructed of one or more water-soluble films shaped to provide at least two internal compartment. Contained within the internal compartment is a liquid or solid detergent composition comprising benefit agents. Upon addition to water, the water-soluble film dissolves releasing the composition into the wash liquor.

Formulators often wish to formulate both solid and liquid compositions into multi-compartment unit dose articles. Such strategy allows formulation flexibility by leveraging the benefits of both formula types.

Solid compositions for inclusion in multi-compartment unit dose articles can be obtained by the same processes as used for the manufacturing of solid laundry powders. These processes have been designed and optimized to deliver solid compositions with a low water content to minimize the caking of the laundry powder composition which are sold and stored in plastic bags or carton boxes. However, a low water composition has the tendency to absorb water from the surrounding environment, and, in the case of laundry powder, when the container holding the composition is left open for a prolonged amount of time, there is some water absorption from the surrounding environment. In the case of a solid composition enclosed in a polymeric film as in a multi-compartment unit dose, the solid composition absorbs water from the polymeric film where water is present as a plasticizer, normally at a level between 4 and 10%. As a consequence of this water absorption, the film becomes brittle and the overall physical stability of the multi-compartment unit dose article is negatively affected. As a further consequence of the water absorption, the solid composition can be subject to caking and therefore experience a decreased dissolution during the washing process, leading to visible residues left on the clothes and decreased overall cleaning performances due to unavailability of some of the cleaning actives.

Thus, there is a need for an effective multi-compartment unit dose article, comprising both liquid and solid compositions, with reduced drawbacks due to water absorption by the solid composition during storage.

### SUMMARY OF THE INVENTION

It has been surprisingly found a solution to this problem in the specific distribution of the active ingredients between the liquid and solid compositions of the multi-compartment unit dose article.

The present disclosure relates to a multi-compartment unit dose article comprising at least a first compartment and a second compartment, wherein the first compartment comprises a solid composition and wherein the second compartment comprises a liquid composition, wherein the solid composition is obtainable by a process comprising the steps of:
preparing a base solid composition wherein the base solid composition comprises less than 5% of water, preferably less than 2.5% of water, even more preferably less than 1% of water; and

adding to the base solid composition from 0.1% to 5% of a perfume microcapsules composition, wherein the perfume microcapsules composition comprises from 20% to 70% by weight of the perfume microcapsules composition of perfume microcapsules and from 0.5% to 5% or from 15% to 30%, by weight of the perfume microcapsules composition of water.

The present disclosure also relates to a method of laundering comprising the step of adding a unit dose article according to the present invention to the drum of an automatic laundry washing machine.

The present disclosure also relates to the use of a perfume microcapsule composition to introduce water to the solid composition of a multi-compartment unit dose article.

### DETAILED DESCRIPTION OF THE INVENTION

Provided is a multi-compartment unit dose article comprising at least a first compartment and a second compartment, wherein the first compartment comprises a solid composition. In order to prevent the solid composition to extract water from the polymeric film, the inventors have surprisingly found that they can introduce water in a very controlled and effective way through the addition of perfume microcapsules into this solid composition.

It has been surprisingly found that the level of water brought in with the perfume microcapsules is the suitable level to maintain the water balance between the solid compartment, the liquid compartment and the polymeric film in a multi-compartment article. The water introduced through the microcapsules is at a level which does not cause caking of the solid composition present in the solid compartment, while being at the same time in balance with the water present in the film as plasticizer. In this situation, there is no transfer of water from the film to the solid composition and the plasticity of the polymeric film is maintained. Perfume microcapsules can be obtained in solid form through several processes, all of which allow maintaining a controlled level of water in the perfume microcapsules in solid form.

Moreover, when introducing perfume microcapsules into the solid composition and not into the liquid composition of the multi-compartment unit dose article, it was also surprisingly found that unwanted leakage of perfume raw materials was reduced, especially those of ClogP below 3, out of the perfume microcapsules, which is particularly severe in liquid compositions comprising high levels of surfactants, especially anionic surfactants preferably used for cleaning, and organic solvents used for the physical stability and polymeric film-liquid composition compatibility. Also, the introduction of perfume microcapsules in the liquid compartment of a multi-compartment unit dose article might require the introduction of a structurant to avoid the coalescence of the perfume microcapsules in aggregates or against the wall of the unit dose detergent. Moreover, the resulting liquid composition comprising the structurant is cloudy, while consumers prefer clear liquids. Such a structurant also adds volume, cost and complexity to the multi-compartment unit dose article and some otherwise suitable structurants may provide further limitations on the types of ingredients that may be incorporated into the liquid. For example the hydrogenated castor oil, used as structurant, is incompatible with lipolytic enzyme inclusion. Suspended materials also need to be well dispersed during manufacturing or else the concentration levels within the formulation vary undesirably from one multi-compartment unit dose article to another, with consequent variable performance and reduced stability. Therefore, the inventors have also found that this construction of the multi-compartment unit dose article, comprising both liquid and solid compositions, and wherein the perfume microcapsules are added only into the solid composition, allows reduced leakage of perfume raw materials form the perfume microcapsules and allows to minimize or even eliminate the structurant.

Perfume microcapsules provide several benefits. They protect the perfume from physical or chemical reactions with incompatible ingredients in the composition, volatilization or evaporation. Perfume microcapsules can be particularly effective in the delivery. Perfumes can be delivered to and retained within the fabric by a microcapsule that only ruptures, and therefore releases the perfume, at a specific washing time, during handling of the wet fabrics by the consumer, or during wear.

In conclusion, by introducing water in a controlled way to the solid composition of a multi-compartment unit dose article through the addition of perfume microcapsules, the inventors were able to minimize the water absorption problem while at the same time avoiding caking of the solid composition in the solid compartment of the multi-compartment unit-dose article, and maximizing the benefit associated with the introduction of perfume through the perfume microcapsules, and without the negatives associated to the need of having a structurant to incorporate the perfume microcapsules in the liquid compartment of a multi-compartment unit-dose article.

The multi-compartment unit dose article of the present invention comprises at least a first compartment and a second compartment, wherein the first compartment comprises a solid composition and wherein the second compartment comprises a liquid composition, wherein the solid composition is obtainable by a process comprising the steps of:
a) preparing a base solid composition; and
b) adding to the base solid composition from 0.1% to 5%, preferably from 0.25% to 4%, even more preferably from 0.5% to 3% of a perfume microcapsules composition, wherein the perfume microcapsules composition comprises from 20% to 70% by weight of the perfume microcapsules composition of perfume microcapsules and from 0.5% to 5%, preferably 1% to 4% or from 15% to 30%, preferably 18% to 25%, by weight of the perfume microcapsules composition of water.

### DEFINITIONS

As used herein, the term “detergent composition” means a product relating to cleaning or treating fabrics or any other surfaces in the area of fabric care.

The term “situs” herein refers to surfaces (e.g., fabrics, hard or soft surfaces, skin, hair) treated with the detergent composition.

As used herein, the term “multi-compartment unit dose article” refers to an article comprising a water-soluble film and at least two compositions contained in at least two separate compartments. The term “compartment” herein refers to a portion of the unit dose article in which a composition is enveloped by the water-soluble film.

The term “perfume” herein is a general term that could refer to perfume raw materials (PRM), perfume delivery system, perfume oil, or a pleasant scent achieved thereby. The term “perfume delivery system” herein refers to the combination or reaction product of perfume raw materials (PRM) with certain chemical compounds, which enhances the deposition efficiency of the perfume onto a situs and/or a controlled release of the perfume.

As used herein, the term “perfume microcapsules composition” refers to a composition comprising perfume microcapsules and that can be in any suitable form such as a slurry or an agglomerate in an aqueous media.

As used herein, the articles including “a” and “an” when used in a claim, are understood to mean one or more of what is claimed or described.

### Multi-Compartment Unit Dose Article

The present invention relates to a multi-compartment unit dose article comprising at least a first compartment and a second compartment. The first compartment comprises a solid composition and the second compartment comprises a liquid composition.

The multi-compartment unit dose article may be formed from a single water-soluble film or from more than one water-soluble film. The multi-compartment unit dose article may comprise two water-soluble films.

The multi-compartment unit dose article can be of any form and shape which are suitable to hold and protect the compositions, e.g. without allowing the release of the compositions from the multi-compartment unit dose article prior to contact of the article to the water. The exact execution will depend on factors like the type and amount of the compositions in the multi-compartment unit dose article, the number of compartments in the multi-compartment unit dose article, the characteristics required for the water-soluble film to hold, protect, and release the compositions. The multi-compartment unit dose article may have a substantially, square, rectangular, oval, elliptoid, supperelliptical, or circular shape. The shape may or may not include any excess material present as a flange or skirt at the point where two or more films are sealed together. By substantially, we herein mean that the shape has an overall impression of being for example square. It may have rounded corners and/or non-straight sides, but overall it gives the impression of being for example square.

The multi-compartment unit dose article comprises a water-soluble film which fully encloses the compositions in at least two compartments. The multi-compartment unit dose article may optionally comprise more than two compartments; said additional compartments may comprise an additional composition. Said additional composition may be liquid, solid, or mixtures thereof. Alternatively, any additional solid component may be suspended in a liquid-filled compartment. A multi-compartment unit dose form may be desirable for such reasons as: separating chemically incompatible ingredients; or where it is desirable for a portion of the ingredients to be released into the wash earlier or later. The unit dose article may comprise at least two, or even at least three, or even at least four, or even at least five, or even at least six compartments.

The multiple compartments may be arranged in any suitable orientation. For example the multi-compartment unit dose article may comprise a bottom compartment, and at least a first top compartment, wherein the top compartment is superposed onto the bottom compartment. The multi-compartment unit dose article may comprise a bottom compartment and at least a first and a second top compartment, wherein the top compartments are arranged side-by-side and are superposed on the bottom compartment; preferably, wherein the article comprises a bottom compartment and at least a first, a second and a third top compartment, wherein the top compartments are arranged side-by-side and are superposed on the bottom compartment.

Alternatively, the compartments may all be positioned in a co-planar configuration.

Alternatively, the compartments may all be positioned in a side-by-side arrangement. In such an arrangement the compartments may be connected to one another and share a dividing wall, or may be substantially separated and simply held together by a connector or bridge. Without wishing to be bound by theory, such an approach reduces migration between compartments.

Alternatively, the compartments may be arranged in a ‘tyre and rim’ orientation, i.e. a first compartment is positioned next to a second compartment, the first compartment at least partially surrounds the second compartment, and may completely enclose the second compartment.

The solid and liquid compositions may be fabric treatment compositions, preferably selected from laundry detergent compositions, laundry conditioning compositions or a mixture thereof.

The term ‘solid’ includes powders, granules, particles, solids, pastilles and mixtures thereof. The solid composition may be a free flowing powder or a compacted powder or a mixture thereof. The term ‘liquid’ includes liquids, gel, paste, dispersion, fluid or a mixture thereof.

The weight ratio between the first and second compartment in the unit dose article may be from 1:1 to 1:25, preferably 1:1 to 1:10, even more preferably 1:1 to 1:8 or from 1:1 to 25:1, preferably 1:1 to 10:1, even more preferably 1:1 to 8:1 respectively.

The unit dose article may be a thermoformed unit dose article. Preferably, the film is thermoformed such that the film of the resultant unit dose article retains a degree of flexibility or elasticity such that it allows referred structural integrity. If the film is too rigid then it may break or split due to the internal forces provided by the compositions.

The multi-compartment unit dose article may be a laundry unit dose article or a household care unit dose article. Suitable laundry multi-compartment unit dose articles include laundry cleaning articles including laundry detergent articles, laundry pre-treat articles, or laundry treatment articles including laundry care articles, laundry freshness articles, laundry softening articles or mixtures thereof. Suitable household care articles include automatic dishwashing articles, hard surface cleaner articles, hand wash articles and mixtures thereof. Preferably, the multi-compartment unit dose article is a laundry cleaning article.

### First Compartment

The first compartment of the multi-compartment unit dose article comprises a solid composition. The solid composition is obtainable by the process comprising the steps of:
a) preparing a base solid composition; and
b) adding to the base solid composition from 0.1% to 5%, preferably from 0.25% to 4%, even more preferably from 0.5% to 3% of a perfume microcapsules composition, wherein the perfume microcapsules composition comprises from 20% to 70% by weight of the perfume microcapsules composition of perfume microcapsules and from 0.5% to 5%, preferably 1% to 4% or from 15% to 30%, preferably 18 to 25%, by weight of the perfume microcapsules composition of water.

Base Solid Composition

The base solid composition may comprise a cleaning active. The cleaning active may be selected from bleach, enzymes, surfactant, polymers, chelants, perfumes or a mixture thereof. Preferably the cleaning active is an enzyme, bleach, a chelant or a mixture thereof.

The base solid composition may comprise any further adjunct cleaning ingredients.

The base solid composition may comprise less than 5% of water, preferably less than 2.5% of water, even more preferably less than 1% of water because a dry composition is easier to process. The addition of water in the solid composition will come essentially from the perfume microcapsules composition.

The level of water in the solid compartment of the multi-compartment unit dose article is measured by measuring the weight loss in 1 gram of solid composition after heating at 105° C. for 3 minutes.

The base solid composition can be made by spray-drying, agglomeration, extrusion, pastillation and combinations thereof.

The base solid composition can preferably be made by a process of admixing and blending separate solid components such as sodium percarbonate granules, sodium silicate granules, sodium carbonate granules, chelant particles such as HEDP and sodium bicarbonate. The particle sizes should ideally be similar in size to avoid segregation. The blending can be done in a wide range of mixing equipment such as mixing-drums, rotary batch mixers, ploughshare mixers, paddle mixers, ribbon blenders, V-blenders or helical screw mixers. Suitable mixers include Munson rotary-batch mixers, Nauta Mixers and Bella paddle mixers. The mixing can be done either continuously or in a batch mode. Some materials could be combined together prior to blending with the other materials. Sodium carbonate and sodium bicarbonate can be supplied as a co-crystal of sodium sesquicarbonate. Sodium carbonate and sodium silicate can also be combined in a co-granule that could be mixed with the other ingredients. Such particles can be made by agglomeration or spray-drying. One range of suitable particles is supplied under the Nabion trade name. In one execution, sodium carbonate powder can be agglomerated with sodium silicate solution (2-ratio silicate at 40% solution) using suitable agglomeration equipment such as a Loedige CB horizontal mixer or a Schugi-type vertical mixer. In such a process, the silicate solution is added to give a desired level of agglomeration. The wet agglomerates are then dried to remove excess water in a fluid bed and then sieved to the desired final particle size. It is important to avoid overdrying the agglomerates so as to maintain silicate solubility and drying temperatures of less than 100° C. can be used. Oversize particles are typically sieved off and ground to the desired size range.

The base solid composition may comprise glycerol. Without wishing to be bound by theory, typically the water-soluble film comprises a plasticizer such as glycerol. The solid composition may draw the plasticizer away from the film thus detrimentally affecting the plasticity, and hence the structural integrity and rigidity. Glycerol present in the solid composition can prevent the transfer of plasticizer from the film as a balance may be obtained between the film and the solid composition whilst still maintaining a sufficient concentration of glycerol in the film.

Perfume Microcapsules Composition

A perfume microcapsules composition is added to the base solid composition. Without wishing to be bound by theory, bringing water via a perfume microcapsules composition allows to maintain the water balance between the solid compartment, the liquid compartment and the polymeric film while at the same time improving the delivery of benefit agents such as perfume and thus improving the overall effectiveness of the multi-compartment unit dose article.

The perfume microcapsules composition is added to the base solid composition in a proportion of from 0.1% to 5%, preferably from 0.25% to 4%, even more preferably from 0.5% to 3%. The perfume microcapsules composition comprises from 20% to 70% by weight of the perfume microcapsules composition of perfume microcapsules and from 0.5% to 5%, preferably 1% to 4% by weight of the perfume microcapsules composition of water or from 15% to 30%, preferably 18% to 25% by weight of the perfume microcapsules composition of water.

The perfume microcapsules composition may be in any suitable form. Preferably, the perfume microcapsules composition may be in the form of an agglomerate or a spray-dried particle, wherein the agglomerate or spray-dried particle comprises water; more preferably, the perfume microcapsules composition may be in the form of a slurry, wherein the microcapsules are comprised within the water; or mixture thereof.

A perfume microcapsule composition in the form of an agglomerate can be used. Such agglomerate may be made by any suitable agglomerating technique including, but not limited to, the techniques disclosed in the application examples and US 2009/0209661 A1.

For the addition of the perfume microcapsules composition by spray drying, spray drying processes for forming detergent compositions are well known in the art and typically involve the steps of forming a detergent slurry, often warmed to 60-80° C. using at least in part heat of anionic surfactant neutralization (e.g. neutralization of linear alkyl benzene sulphonic acid). The slurry has typically a water content of between 30%-60% and may comprise a builder, a neutralized or acid-form anionic surfactant, a nonionic surfactant, a neutralizing alkali such as soda ash or sodium carbonate, an inorganic salt or salts such as sodium sulphate, water, processing aids, and organic polymers in a crutcher. The detergent slurry is pumped to the top of a spray drying tower, and sprayed from nozzles in the tower to form atomized droplets.

These compositions can also be prepared by continuous slurry making. By continuous slurry making is meant a process in which components are fed continuously and substantially simultaneously to a slurry making vessel while mixed, the slurry is removed to the spray tower at a rate which maintains an essentially constant volume in the vessel. Hot air is pumped through the spray drying towers such that when the atomized droplets are sprayed into the hot air, they dry into a solid as the free moisture evaporates. The spray-dried granules thus formed are then collected at the bottom of the tower.

The perfume microcapsules can be added to the base composition via mixing (e.g., with a paddle mixer) or by spraying on.

It is generally advantageous to add the perfume microcapsules by spraying on. It has proven very advantageous in this regard to add surfactant to the microcapsule slurry to stabilize the latter, wherein cationic, anionic and/or non-ionic surfactant is added as the surfactant, preferably non-ionic surfactant, especially ethoxylated oxo alcohol is suitable. These kinds of stabilized microcapsule slurries have better processability by avoiding reversible flocculation. In this respect, anionic surfactants can be advantageously added in amounts of 1 wt % to 40 wt %, preferably 2 wt % to 30 wt %, more preferably 3 wt % to 20 wt % for stabilizing the dispersion, the wt % being relative to the total dispersion. Cationic surfactants can be advantageously added in amounts of 0.001 wt % to 4 wt %, preferably 0.01 wt % to 3 wt % and more preferably 0.1 wt % to 2 wt % for stabilizing the dispersion, the wt % being relative to the total dispersion. Non-ionic surfactants can be advantageously added, in amounts of 0.01 wt % to 20 wt %, preferably 0.1 wt % to 15 wt %, more preferably 1 wt % to 10 wt % for stabilizing the dispersion, the wt % being relative to the total dispersion.

The use of non-ionic surfactants to stabilize aqueous microcapsule dispersions has proven to be particularly advantageous. Fatty alcohol ethoxylates, oxo alcohol ethoxylates, alkylphenol polyglycol ethers, fatty acid ethoxylates, fatty amine ethoxylates, ethoxylated triacylglycerols and mixed ethers (alkylated polyethylene glycol ether on both sides) as well as alkyl polyglucosides, saccharose esters, sorbitol esters, sucrose esters, fatty acid glucamides as well as amine oxides are particularly advantageously usable.
The use of oxo alcohol ethoxylates is particularly advantageous in regard to the desired stabilization of the microcapsule dispersions. Preferred oxo alcohol ethoxylates are derived from oxo alcohols with 9 to 15 carbon atoms, onto which preferably 3 to 15 moles of ethylene oxide have been added. A particularly preferred oxo alcohol ethoxylate in the context of the invention is C13-C15 oxo alcohol, onto which 7 moles of ethylene oxide have been added. A suitable commercial product is e.g. Lutensol® AO 7 from BASF. The addition of oxo alcohol ethoxylates can reduce or eliminate the reversible flocculation.

The perfume microcapsules composition may comprise perfume microcapsules formed by at least partially surrounding the perfume raw materials with a shell material. The microcapsule shell material may comprise: melamine, polyacrylamide, silicones, silica, polystyrene, polyurea, polyurethanes, resorcinol, gelatin, polyamides, and mixtures thereof. Said melamine shell material may comprise melamine crosslinked with formaldehyde, melamine-dimethoxyethanol crosslinked with formaldehyde, and mixtures thereof. Said polystyrene shell material may comprise polyestyrene cross-linked with divinylbenzene. Said polyurea shell material may comprise urea crosslinked with formaldehyde, urea crosslinked with gluteraldehyde, and mixtures thereof.

The perfume microcapsule may be coated with a deposition aid, a cationic polymer, a non-ionic polymer, an anionic polymer, or mixtures thereof. Suitable polymers may be selected from the group consisting of: polyvinylformaldehyde, partially hydroxylated polyvinylformaldehyde, polyvinylamine, polyethyleneimine, ethoxylated polyethyleneimine, polyvinylalcohol, chitosan and chitosan derivatives and combinations thereof.

### Second Compartment

The second compartment of the multi-compartment unit dose article comprises a liquid composition.
The liquid composition may comprise a cleaning active. The cleaning active may be selected from surfactant, polymers, perfumes, bleaches, enzymes or a mixture thereof.

The liquid compartment may comprise less than 1%, preferably less than 0.5% and more preferably less than 0.1% of structurant. Adding a structurant to the liquid composition renders the process of making such composition more complex, reduces the volume in the liquid compartment of a multi-compartment unit dose article available for active ingredients which provide consume benefits and brings water to the composition, ultimately affecting the physical stability of the water-soluble film enclosing the multi-compartment unit-dose article.

Examples of such structurant comprise a material selected from the group consisting of polysaccharides, modified celluloses, modified proteins, inorganic salts, quaternized polymeric materials, imidazoles; nonionic polymers, polyurethanes, bacterial cellulose, coated bacterial cellulose, non-polymeric crystalline hydroxyl-functional materials, polymeric structuring agents, di-amido gellants and mixtures thereof.

The liquid composition may comprise any further adjunct ingredients.

The pH of the liquid composition may be between 5 and 9, preferably between 6 and 8. Preferably, the liquid composition comprises between 0.5% and 30%, or even between 1% and 20%, or even between 2% and 15% by weight of the liquid composition of water.

The pH is measured on the composition diluted at 10% in water, at 25° C., using a Sartarius PT-10P pH meter with gel-filled probe (such as the Toledo probe, part number 52 000 100), calibrated according to the instructions manual.

### Water-Soluble Film

The film of the unit dose article is soluble or dispersible in water, and preferably has a water-solubility of at least 50%, preferably at least 75%, more preferably at least 95%, as measured by the method set out here after using a glass-filter with a maximum pore size of 20 micrometers (μm):

Preferred films exhibit good dissolution in cold water, meaning unheated water straight from the tap. Preferably such films exhibit good dissolution at temperatures below 25° C., more preferably below 21° C., more preferably below 15° C. By good dissolution it is meant that the film exhibits water-solubility of at least 50%, preferably at least 75% or even at least 95%, as measured by the method set out here after using a glass-filter with a maximum pore size of 20 μm, described below.

Preferred film materials are preferably polymeric materials. The film material can, for example, be obtained by casting, blow-moulding, extrusion or blown extrusion of the polymeric material, as known in the art.

Preferred polymers, copolymers or derivatives thereof suitable for use as pouch material are selected from polyvinyl alcohols, polyvinyl alcohol copolymers and hydroxypropyl methyl cellulose (HPMC), polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum, polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, polyvinyl alcohols, polyvinyl alcohol copolymers and hydroxypropyl methyl cellulose (HPMC) and most preferably selected from polyvinyl alcohols, polyvinyl alcohol copolymers and hydroxypropyl methyl cellulose (HPMC), and combinations thereof.

Preferably, the level of polymer in the pouch material, for example a PVA polymer, is at least 60%. The polymer can have any weight average molecular weight, preferably from about 1000 to 1,000,000 Da, more preferably from about 10,000 to 300,000 Da, yet even more preferably from about 20,000 to 150,000 Da. Preferred films are those supplied by Monosol under the trade references M8630, M8900, M8779, M8310.

The film material herein can also comprise one or more additive ingredients. For example, it can be beneficial to add plasticisers, for example glycerol, ethylene glycol, diethyleneglycol, propylene glycol, sorbitol and mixtures thereof. Other additives may include water and functional detergent additives, including water, to be delivered to the wash water, for example organic polymeric dispersants, etc.

The film may be lactone free. By this we mean that the film does not comprise any lactone. Alternatively, the film may comprise very low levels of lactone that are present due to impurities but which have not been deliberately added. However, essentially the film will be free of lactone.

The film may be opaque, translucent or transparent.

The film used in the multi-compartment unit dose article may have a thickness of between 10 and 200 μm, or even between 15 and 150 μm, or even between 20 and 100 μm.

Method of Measuring the Water-Solubility of the Film:

50 grams±0.1 gram of film material is added in a pre-weighed 400 ml beaker and 245 ml±1 ml of distilled water is added. This is stirred vigorously on a magnetic stirrer set at 600 rpm, for 30 minutes. Then, the mixture is filtered through a sintered-glass filter with a pore size as defined above (max. 20 μm). The water is dried off from the collected filtrate by any conventional method, and the weight of the remaining material is determined (which is the dissolved or dispersed fraction). Then, the percentage solubility or dispersability can be calculated.

### Fabric Softening Ingredient

The multi-compartment unit dose article may comprise a fabric softening ingredient. The fabric softening ingredient is preferably present in the solid composition of the multi-compartment unit dose article. The fabric softening ingredient is preferably selected from the group comprising quaternised polymers, non-quaternised cellulosic polymers, quaternary amines, clays, sucrose esters, silicones, and mixtures thereof. More preferably the fabric softening ingredient is selected from quaternised cellulosic polymers, quaternary ammonium compounds, cationic organic silicones, silicone doped clays and mixtures thereof.

Suitable cationic polymers include the polyquaternium polymers, as in the CTFA Cosmetic Ingredient Dictionary (The Cosmetic, Toiletry and Fragrance, Inc. 1997), in particular the polyquaternium-6, polyquaternium-7, polyquaternium-10 polymers (Ucare Polymer IR 400; Amerchol), also referred to as merquats, polyquaternium-4 copolymers, such as graft copolymers with a cellulose backbone and quaternary ammonium groups which are bonded via allyldimethylammonium chloride, cationic cellulose derivatives, such as cationic guar, such as guar hydroxypropyltriammonium chloride, and similar quaternized guar derivatives (e.g. Cosmedia Guar, manufacturer: BASF GmbH), cationic quaternary sugar derivatives (cationic alkyl polyglucosides), e.g. the commercial product Glucquat® 100, according to CTFA nomenclature a “Lauryl Methyl Gluceth-10 Hydroxypropyl Dimonium Chloride”, copolymers of PVP and dimethylaminomethacrylate, copolymers of vinylimidazole and vinylpyrrolidone, aminosilicone polymers and copolymers.

It is likewise possible to use polyquaternized polymers (e.g. Luviquat Care from BASF) and also cationic biopolymers based on chitin and derivatives thereof, for example the polymer obtainable under the trade name Chitopharm® (manufacturer: BASF).

Likewise suitable according to the invention are cationic silicone oils, such as, for example, the commercially available products Q2-7224 (manufacturer: Dow Corning; a stabilized trimethylsilylamodimethicone), Dow Corning 929 emulsion (comprising a hydroxyl-amino-modified silicone, which is also referred to as amodimethicone), SM-2059 (manufacturer: General Electric), SLM-55067 (manufacturer: Wacker) Abil®-Quat 3270 and 3272 (manufacturer: Evonik; diquaternary polydimethylsiloxanes, quaternium-80) and Siliconquat Rewoquat® SQ 1 (Tegopren® 6922, manufacturer: Evonik).

Particularly preferred examples of the cationic alkyloligoglucosides are the compounds having the INCI names Polyquaternium-77, Polyquaternium-78, Polyquaternium-79, Polyquaternium-80, Polyquaternium-81, and Polyquaternium-82. The cationic alkyloligoglucosides having the names Polyquaternium-77, Polyquaternium-81, and Polyquaternium-82 are highly preferred.

The fabric softening ingredient may comprise a quaternised polymer, wherein the quaternised polymer has a molecular weight of between 30,000 Daltons (Da) and 2,000,000 Da. The quaternised polymer may have a charge density of between 0.1% and 5% nitrogen.

The fabric softening ingredient may comprise a hydroxyethyl cellulose, hydroxypropyl cellulose or mixtures thereof.

Another suitable cellulosic polymer is hydroxyethyl cellulose. The hydroxyethylcellulose may comprise a hydrophobically modified hydroxyethylcellulose. By ‘hydrophobically modified’, we herein mean that one or more hydrophobic groups are bound to the polymer backbone. The hydrophobic group may be bound to the polymer backbone via an alkylene group, preferably a C₁₋₆ alkylene group.

Preferably, the hydrophobic group is selected from linear or branched alkyl groups, aromatic groups, polyether groups, or a mixture thereof.

The hydrophobic group may comprise an alkyl group. The alkyl group may have a chain length of between C₈ and C₅₀, preferably between C₈ and C₂₆, more preferably between C₁₂ and C₂₂, most preferably between C₁₆ and C₂₀.

The hydrophobic group may comprise a polyalkylene glycol, preferably wherein the polalkylene glycol is selected from polyethylene glycol, polypropylene glycol, or a mixture thereof. The polyethylene glycol may comprise a copolymer comprising oxyethylene and oxypropylene units. The copolymer may comprise between 2 and 30 repeating units, wherein the terminal hydroxyl group of the polyalkylene glycol is preferably esterified or etherized. Preferably, the ester bond is formed with an acid selected from a C₅₋₅₀ carboxylic acid, preferably C₈₋₂₆ carboxylic acid, more preferably C₁₆₋₂₀ carboxylic acid, and wherein the ether bond is preferably formed with a C₅₋₅₀ alcohol, more preferably C₈₋₂₆ alcohol, most preferably a C₁₆₋₂₀ alcohol.

### Deposition Aid:

The solid composition may comprise from about 0.01% to about 10%, from about 0.05 to about 5%, or from about 0.15 to about 3% of a deposition aid. The deposition aid may be a cationic or amphoteric polymer. The deposition aid may be a cationic polymer. The cationic polymer may comprise a cationic acrylate such as Rheovis CDE™. Cationic polymers in general and their method of manufacture are known in the literature. The cationic polymer may have a cationic charge density of from about 0.005 to about 23, from about 0.01 to about 12, or from about 0.1 to about 7 milliequivalents/g, at the pH of intended use of the composition. For amine-containing polymers, wherein the charge density depends on the pH of the composition, charge density is measured at the intended use pH of the product. Such pH will generally range from about 2 to about 11, more generally from about 2.5 to about 9.5. Charge density is calculated by dividing the number of net charges per repeating unit by the molecular weight of the repeating unit. The positive charges may be located on the backbone of the polymers and/or the side chains of polymers.

Suitable polymers may be selected from the group consisting of cationic or amphoteric polysaccharide, polyethylene imine and its derivatives, and a synthetic polymer made by polymerizing one or more cationic monomers selected from the group consisting of N,N-dialkylaminoalkyl acrylate, N,N-dialkylaminoalkyl methacrylate, N,N-dialkylaminoalkyl acrylamide, N,N-dialkylaminoalkylmethacrylamide, quaternized N,N-dialkylaminoalkyl acrylate quaternized N,N-dialkylaminoalkyl methacrylate, quaternized N,N-dialkylaminoalkyl acrylamide, quaternized N,N-dialkylaminoalkylmethacrylamide, methacryloamidopropyl-pentamethyl-1,3-propylene-2-ol-ammonium dichloride, N,N,N,N′,N′,N″,N″-heptamethyl-N″-3-(1-oxo-2-methyl-2-propenyl)aminopropyl-9-oxo-8-azo-decane-1,4,10-triammonium trichloride, vinylamine and its derivatives, allylamine and its derivatives, vinyl imidazole, quaternized vinyl imidazole and diallyl dialkyl ammonium chloride and combinations thereof, and optionally a second monomer selected from the group consisting of acrylamide, N,N-dialkyl acrylamide, methacrylamide, N,N-dialkylmethacrylamide, C1-C12 alkyl acrylate, C1-C12 hydroxyalkyl acrylate, polyalkylene glycol acrylate, C1-C12 alkyl methacrylate, C1-C12 hydroxyalkyl methacrylate, polyalkylene glycol methacrylate, vinyl acetate, vinyl alcohol, vinyl formamide, vinyl acetamide, vinyl alkyl ether, vinyl pyridine, vinyl pyrrolidone, vinyl imidazole, vinyl caprolactam, and derivatives, acrylic acid, methacrylic acid, maleic acid, vinyl sulfonic acid, styrene sulfonic acid, acrylamidopropylmethane sulfonic acid (AMPS) and their salts. The polymer may optionally be branched or cross-linked by using branching and crosslinking monomers. Branching and crosslinking monomers include ethylene glycoldiacrylate divinylbenzene, and butadiene. A suitable polyethyleneinine useful herein is that sold under the tradename Lupasol® by BASF, AG, Lugwigschaefen, Germany.

The solid composition may comprise an amphoteric deposition aid polymer so long as the polymer possesses a net positive charge. Said polymer may have a cationic charge density of about 0.05 to about 18 milliequivalents/g.

The average molecular weight of the polymer may be from about 500 to about 5,000,000 Da or from about 1,000 to about 2,000,000 Da or from about 2,500 to about 1,500,000 Da, as determined by size exclusion chromatography relative to polyethyleneoxide standards with RI detection. The molecular weight of the cationic polymer may be from about 500 to about 37,500 Da.

The solid composition may comprise any further adjunct ingredients.

Chelant

The liquid composition or the solid composition, and combination thereof, preferably the solid composition of the multi-compartment unit dose article may comprise a chelant, preferably HEDP (1-hydroxyethane 1,1-diphosphonic acid) sequestrant or a salt thereof. The HEDP is present in the solid composition in the form of loose packed granules and may comprise at least 25%, preferably at least 30%, more preferably at least 40% by weight of HEDP; and the HEDP may further comprises 1.5% by weight or less of fines particles with a particle of less than 180 μm and 3.0% by weight or less of fines particles with a particle size of less than 355 μm.

The term ‘fines’ refers to a granular fraction present in for example HEDP and which may arise from a breakdown of the compound during manufacture and processing.

Also, the HEDP may comprise 1.0% or less by weight of fines particles with a particle size distribution of less than 180 μm; more preferably 0.5% or less by weight of fines particles with a particle size distribution of less than 180 μm.

In addition, in the multi-compartment unit dose article according to the present invention the HEDP may comprise 2.0% or less by weight of fines particles with a particle size distribution of less than 355 μm. In the capsules of the present invention, the HEDP granules are preferably HEDP tetra sodium salt. However, it will be appreciated by the skilled reader that alternative suitable salts may be employed consistent with laundry applications.

It is also preferred that the mean particle size of the HEDP granules in the multi-compartment unit dose articles is in the range 600 to 950 μm. More preferably, the mean particle size of the HEDP granules in the multi-compartment unit dose articles is in the range 800 to 950 μm. Most preferably the mean particle size of the HEDP granules in the multi-compartment unit dose articles is in the range 875 to 925 μm. It is also preferred that in the multi-compartment unit dose article according to the present invention the solid compartment comprises 2 grams or less of HEDP and the liquid compartment comprises 20 to 45 grams of liquid. More preferably, the solid compartment comprises 2 grams or less of HEDP and the liquid compartment comprise 20 to 30 grams of liquid. Most preferably, the solid compartment comprises 2 grams or less of HEDP and the liquid compartment comprises 18 to 23 grams of liquid.

According to a second aspect of the present invention there is provided a method of preparing a batch of HEDP granules for use in a multi-compartment unit dose article according to a first aspect of the present invention wherein the HEDP granules are sieved one or more times prior to inclusion in the multi-compartment unit dose article; and wherein once sieved the batch of HEDP granules comprise 1.5% by weight or less of fines particles with a particle of less than 180 μm and 3.0% by weight or less of fines particles with a particle size of less than 355 μm. In the method of the present invention, the HEDP granules may be sieved twice or more times prior to inclusion in the multi-compartment unit dose article; and wherein once sieved the batch of HEDP granules comprise 1.0% by weight or less of fines particles with a particle of less than 180 μm and 2.0% by weight or less of fines particles with a particle size of less than 355 μm.

The liquid composition or the solid composition, and combination thereof, preferably the solid composition of the multi-compartment unit dose article may comprise a chelant, preferably an organic acid or a salt thereof, more preferably citric acid or a salt thereof, citrate, preferably alkaline or alkaline earth citrate, more preferably sodium citrate. The sodium citrate is preferably present in the solid composition in the form of loose packed granules and may comprise at least 25%, preferably at least 30%, more preferably at least 40% by weight of sodium citrate.

### Bleach

Bleach may be present in the solid or the liquid compositions, preferably in the solid compositions. Suitable bleaching agents include photobleaches, bleach activators, hydrogen peroxide, sources of hydrogen peroxide, pre-formed peracids, bleach catalysts and mixtures thereof. In general, when a bleaching agent is used, the composition may comprise from about 0.1% to about 50% or even from about 0.1% to about 25% bleaching agent by weight of the composition.

Preferably the bleach comprises percarbonate. Also preferred are bleaches comprising coated percarbonate and coated or uncoated PAP or coated percarbonate and coated or uncoated DAP.

### Enzymes

The compositions can comprise one or more enzymes which provide cleaning performance or fabric care benefits, or a combination of both. Examples of suitable enzymes include, but are not limited to, hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is an enzyme cocktail that may comprise, for example, a protease and lipase in conjunction with amylase. The enzyme may be a lipase. When present in a fabric and home care product, the aforementioned enzymes may be present at levels from about 0.00001% to about 2%, from about 0.0001% to about 1% or even from about 0.001% to about 0.5% enzyme protein by weight of the fabric and home care product.

### Anionic Surfactant

Suitable anionic surfactants useful herein can comprise any of the conventional anionic surfactant types typically used in detergent compositions. These include the alkyl benzene sulfonic acids and their salts as well as alkoxylated or non-alkoxylated alkyl sulfate materials.

At least one composition, preferably the solid composition may comprise a coated bleach, preferably a coated percarbonate and a coated enzyme. Without wishing to be bound by theory, it was surprisingly found that the activity of the enzyme was improved wherein it was coated and in the presence of a coated percarbonate.

Exemplary anionic surfactants are the alkali metal salts of C10-C16 alkyl benzene sulfonic acids, or C11-C14 alkyl benzene sulfonic acids. The alkyl group may be linear and such linear alkyl benzene sulfonates are known as “LAS”. Alkyl benzene sulfonates, and particularly LAS, are well known in the art. Such surfactants and their preparation are described for example in U.S. Pat. Nos. 2,220,099 and 2,477,383. Especially useful are the sodium and potassium linear straight chain alkylbenzene sulfonates in which the average number of carbon atoms in the alkyl group is from about 11 to 14. Sodium C11-C14, e.g., C12, LAS is a specific example of such surfactants.

Specific, non-limiting examples of anionic surfactants useful herein include: a) C11-C18 alkyl benzene sulfonates (LAS); b) C10-C20 primary, branched-chain and random alkyl sulfates (AS), including predominantly C12 alkyl sulfates; c) C10-C18 secondary (2,3) alkyl sulfates having formulae (I) and (II): wherein M in formulae (I) and (II) is hydrogen or a cation which provides charge neutrality, and all M units, whether associated with a surfactant or adjunct ingredient, can either be a hydrogen atom or a cation depending upon the form isolated by the artisan or the relative pH of the system wherein the compound is used, with non-limiting examples of suitable cations including sodium, potassium, ammonium, and mixtures thereof, and x is an integer of at least about 7, or at least about 9, and y is an integer of at least 8, or at least about 9; d) C10-C18 alkyl alkoxy sulfates (AExS) wherein x is from 1-30; e) C10-C18 alkyl alkoxy carboxylates in one aspect, comprising 1-5 ethoxy units; f) mid-chain branched alkyl sulfates as discussed in U.S. Pat. No. 6,020,303 and U.S. Pat. No. 6,060,443; g) mid-chain branched alkyl alkoxy sulfates as discussed in U.S. Pat. No. 6,008,181 and U.S. Pat. No. 6,020,303; h) modified alkylbenzene sulfonate (MLAS) as discussed in WO 99/05243, WO 99/05242, WO 99/05244, WO 99/05082, WO 99/05084, WO 99/05241, WO 99/07656, WO 00/23549, and WO 00/23548; i) methyl ester sulfonate (MES); and j) alpha-olefin sulfonate (AOS).

A suitable anionic detersive surfactant is predominantly alkyl C16 alkyl mid-chain branched sulphate. A suitable feedstock for predominantly alkyl C16 alkyl mid-chain branched sulphate is beta-farnesene, such as BioFene™ supplied by Amyris, Emeryville, Calif.

### Nonionic Surfactant

Suitable nonionic surfactants for use herein include the alcohol alkoxylate nonionic surfactants. Alcohol alkoxylates are materials which correspond to the general formula: R1(CmH2mO)nOH wherein R1 is a C8-C16 alkyl group, m is from 2 to 4, and n ranges from about 2 to 12. R1 may be an alkyl group, which may be primary or secondary, that comprises from about 9 to 15 carbon atoms, or from about 10 to 14 carbon atoms. The alkoxylated fatty alcohols may also be ethoxylated materials that contain on average from about 2 to 12 ethylene oxide moieties per molecule, or from about 3 to 10 ethylene oxide moieties per molecule.

### Other Additional Elements:

The multi-compartment unit dose article, the solid and or liquid compositions may comprise a dye. Dyes include substantive and non-substantive dyes. Substantive dyes include hueing dyes. The hueing dyes employed in the present laundry detergent compositions may comprise polymeric or non-polymeric dyes, pigments, or mixtures thereof.

The multi-compartment unit dose article, the solid and or liquid compositions may comprise a brightener. Suitable brighteners are stilbenes, such as brightener 15. Other suitable brighteners are hydrophobic brighteners and brightener 49. The brightener may be in micronized particulate form, having a weight average particle size in the range of from 3 to 30 μm, or from 3 μm to 20 μm, or from 3 to 10 μm. The brightener can be alpha or beta crystalline form.

The multi-compartment unit dose article, the solid and or liquid compositions herein may also optionally contain one or more copper, iron and/or manganese chelating agents. If utilized, chelating agents will generally comprise from about 0.1% by weight of the compositions herein to about 15%, preferably from about 3.0% to about 15% by weight of the compositions herein. Preferably, if present, the chelant is present in the solid composition. Without wishing to be bound by theory, there is a tendency for chelants to crystallize at higher levels in liquid compositions. Higher levels are desirable to help maintain cleaning performance in the wash liquor.

The multi-compartment unit dose article, the solid and or liquid compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in the compositions herein, the dye transfer inhibiting agents are present at levels from about 0.0001%, from about 0.01%, from about 0.05% by weight of the cleaning compositions to about 10%, about 2%, or even about 1% by weight of the cleaning compositions.

The multi-compartment unit dose article, the solid and/or liquid compositions may comprise one or more polymers. Suitable polymers include carboxylate polymers, polyethylene glycol polymers, polyester soil release polymers such as terephthalate polymers, amine polymers, cellulosic polymers, dye transfer inhibition polymers, dye lock polymers such as a condensation oligomer produced by condensation of imidazole and epichlorhydrin, optionally in ratio of 1:4:1, hexamethylenediamine derivative polymers, and any combination thereof.

Other suitable cellulosic polymers may have a degree of substitution (DS) of from 0.01 to 0.99 and a degree of blockiness (DB) such that either DS+DB is of at least 1.00 or DB+2DS−DS² is at least 1.20. The substituted cellulosic polymer can have a degree of substitution (DS) of at least 0.55. The substituted cellulosic polymer can have a degree of blockiness (DB) of at least 0.35. The substituted cellulosic polymer can have a DS+DB, of from 1.05 to 2.00. A suitable substituted cellulosic polymer is carboxymethylcellulose.

The multi-compartment unit dose article, the solid and/or liquid compositions may comprise a suds suppressor. Suitable suds suppressors include silicone and/or fatty acid such as stearic acid. The multi-compartment unit dose article, the solid and/or liquid compositions may also comprise non-encapsulated free perfume material and the liquid composition may comprise less than 1%, preferably less than 0.5% and more preferably less than 0.1% of perfume. A part or the whole non-encapsulated free perfume material can be added to the solid composition at the same time and through the same addition route of the perfume microcapsules.

In addition to perfume microcapsules, the multi-compartment unit dose article, the solid and/or liquid compositions may comprise one or more additional perfume delivery technologies that stabilize and enhance the deposition and release of perfume ingredients from treated substrate. Such perfume delivery technologies can also be used to increase the longevity of perfume release from the treated substrate. The multi-compartment unit dose article, the solid and/or liquid compositions may comprise from about 0.001% to about 20%, preferably from about 0.01% to about 10%, more preferably from about 0.05% to about 5%, or even more preferably from about 0.1% to about 0.5% by weight of the additional perfume delivery technology. Said additional perfume delivery technologies may be selected from the group consisting of: pro-perfumes, polymer particles, functionalized silicones, polymer assisted delivery, molecule assisted delivery, fiber assisted delivery, amine assisted delivery, cyclodextrins, starch encapsulated accord, zeolite and inorganic carrier, and mixtures thereof.

### Method of Laundering

The present invention is also to a method of laundering using an article according to the present invention, comprising the steps of, placing at least one article according to the present invention into the washing machine along with the laundry to be washed, and carrying out a washing or cleaning operation.

Any suitable washing machine may be used. Those skilled in the art will recognize suitable machines for the relevant wash operation. The article of the present invention may be used in combination with other compositions, such as fabric additives, fabric softeners, rinse aids and the like.

The wash temperature may be 30° C. or less. The wash process may comprise at least one wash cycle having a duration of between 5 and 20 minutes. The automatic laundry machine may comprise a rotating drum, and wherein during at least one wash cycle, the drum has a rotational speed of between 15 and 40 rpm, preferably between 20 and 35 rpm.

### Use of a Perfume Microcapsule Composition

As explained in the summary of the invention, by introducing water in a controlled way to the solid composition of a multi-compartment unit dose article through the addition of perfume microcapsules, the inventors were able to solve the technical problem. As such, a third aspect of the present invention is the use of a perfume microcapsule composition to introduce water to the solid composition of a multi-compartment unit dose article.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

### EXAMPLES

### Example 1: 80% Core/20 wt % Wall Melamine Based Polyurea Capsule

A first mixture is prepared by combining 208 grams of water and 5 grams of alkyl acrylate-acrylic acid copolymer (Polysciences, Inc. of Warrington, Pa., USA). This first mixture is adjusted to pH 5.0 using acetic acid. 125 grams of the capsule core material comprising a fragrance oil is added to the first mixture at a temperature of 45° C. to form an emulsion. The ingredients to form the capsule wall material are prepared as follows: 9 grams of a corresponding capsule wall material copolymer pre-polymer (butylacrylate-acrylic acid copolymer) and 90 grams of water are combined and adjusted to pH 5.0. To this mixture is added 28 grams of a partially methylated methylol melamine resin solution (“Cymel 385”, 80% solids, Cytec). This mixture is added to the above described fragrance oil-in-water emulsion with stirring at a temperature of 45 degrees Centigrade. High speed blending is used to achieve a volume-mean particle size of 15 μm. The temperature of the mixture is gradually raised to 65 degrees Centigrade, and is maintained at this temperature overnight with continuous stirring to initiate and complete encapsulation. To form the acrylic acid-alkyl acrylate copolymer capsule wall, the alkyl group can be selected from ethyl, propyl, butyl, amyl, hexyl, cyclohexyl, 2-ethylhexyl, or other alkyl groups having from one to about sixteen carbons, preferably one to eight carbons.

### Example 2: Perfume Micro-Capsules Agglomerate with CMC (Carboxymethyl Cellulose) and CatHEC (Cationically Modified Hydroxyethyl Cellulose)

A 9 kg aliquot of perfume microcapsule slurry of Example 1 is mixed using a Eurostar mixer (IKA) with a R1382 attachment at a constant speed of 200 RPM. To the aliquot 300 g of carboxymethyl cellulose (CP Kelco) and 300 g of CatHEC (DOW) is added while mixing using the Eurostar mixer with same attachment and speed as described above. The slurry is mixed for a total of two hours or until a uniform paste is formed.

### Example 3: Perfume Micro-Capsules Agglomerate with CMC and CatHEC (Catatonically Modified Hydroxyethylcellulose) Containing Chelant

A 9 kg aliquot of perfume microcapsule slurry of Example 1 is mixed using a Eurostar mixer (IKA) with a R1382 attachment at a constant speed of 200 RPM. To the aliquot, 5.4 g of ethylenediaminedisuccinicacid (EDDS), followed by 300 g of carboxymethyl cellulose (CP Kelco) and 300 g of CatHEC (DOW) is added while mixing using the Eurostar mixer with same attachment and speed as described above. The slurry is mixed for a total of two hours or until a uniform paste is formed.

### Example 4: Perfume Micro-Capsules Agglomerate with CMC(Carboxy Methyl Cellulose)

A 9 kg aliquot of perfume microcapsule slurry of Example 1 is mixed using a Eurostar mixer (IKA) with a R1382 attachment at a constant speed of 200 RPM. To the aliquot 500 g of carboxymethyl cellulose (CP Kelco) is added while mixing using the Eurostar mixer with same attachment and speed as described above. The slurry is mixed for a total of two hours or until a uniform paste is formed.

### Example 5: Examples of Multi-Compartment Unit Dose Articles According to the Invention

Table 3 and table 4 below represent examples of multi-compartment unit-dose formulations falling within the scope of the present invention.

TABLE 3
A2 represents a solid composition enclosed within a first compartment.
A1 represents a liquid composition enclosed within a second compartment.
All levels are in weight percent of the composition. The ratio between
solid and liquid compositions is about 1:2, comprising 7.5 grams of
solid composition and 14 grams of liquid composition.

| | A₁ Liquid | A₂ Solid |
|---|---|---|
| Ingredients (% w/w) | (weight %) | (weight %) |
| Linear C₁₀-C₁₃ Alkylbenzene sulfonic acid | 24.5 | — |
| C₁₃₋₁₅ alkyl 8-ethoxylate | 24.0 | — |
| Sodium Carbonate | — | 3.9 |
| Sodium Bicarbonate | | 12.0 |
| Sodium Silicate | | 10.2 |
| Tetraacetylethylenediamine | — | 10.6 |
| Sodium percarbonate | | 30.1 |
| C₁₂₋₁₈ Fatty acid | 8.4 | — |
| Chelants | 1.5 | — |
| Dyes, perfume, minors | 4.0 | 2.2 |
| Brightener¹ | 0.5 | 0.02 |
| Sulfate | | 11.4 |
| Zeolite | | 3.38 |
| Enzymes | — | 3.7 |
| Carboxymethyl cellulose | — | 7.7 |
| Soil Release Polymer² | 1.2 | 1.0 |
| Ethoxylated Polyethyleneimine³ | 4.4 | — |
| 1,2-propanediol | 2.6 | |
| Glycerol | 13.3 | |
| Ethanol | 1.5 | |
| Mono-ethanolamine | 6.8 | — |
| Water | 7.3 | 1.0 |
| Sodium Chloride | | 1.8 |
| Perfume microcapsules according to | | 1.0 |
| example 1 (expressed as percentage | | |
| of encapsulated perfume oil) | | |

¹Disodium 2,2′-((1,1′-biphenyl)-4,4′-diyldivinylene)bis(benzenesulphonate) (Tinopal ® CBS ex BASF)
²Polypropylene terephthalate
³Ethoxylated Polyethyleneimine (Sokalan HP ® 20 ex BASF)

TABLE 4
B2 represents a solid composition enclosed within a first compartment.
B1 represents a liquid composition enclosed within a second compartment.
All levels are in weight percent of the composition. All levels are in
weight percent of the composition. The ratio between solid and liquid
compositions is about 1:2, comprising 7.5 grams of solid
composition and 14 grams of liquid composition.

| | B₁ Liquid | B₂ Solid |
|---|---|---|
| Ingredients (% w/w) | (weight %) | (weight %) |
| Linear C₁₀-C₁₃ Alkylbenzene sulfonic acid | 25.3 | 23.0 |
| Alkyl sulphate with an average degree of | — | 6.0 |
| ethoxylation of 1, neutralized with | | |
| ethanolamine | | |
| C13-15 alkyl 8-ethoxylate | 30.2 | — |
| Methylesthersulfonate | — | 5 |
| Sodium bicarbonate | | 11.5 |
| C₁₂-₁₈ Fatty acid | 10.0 | — |
| Soap | — | 1.45 |
| Chelants | 0.7 | — |
| Perfume, dyes, minors | 2.7 | 2.2 |
| Enzymes | — | 3.5 |
| Carboxymethyl cellulose | — | 7.2 |
| Brightener¹ | 0.3 | 0.01 |
| Sodium Sulphate | | 10.6 |
| Sodium Carbonate | | 6.64 |
| Sodium Silicate | | 11.7 |
| Zeolite | — | 4.2 |
| Ethoxylated Polyethylenimine² | 3.0 | — |
| Stain removal polymer³ | 1.2 | 0.8 |
| 1,2-propanediol | 6.5 | |
| Glycerol | 4.5 | — |
| Ethanol | 2.0 | — |
| Mono-ethanolamine | 7.6 | — |
| Water | 6.0 | 0.8 |
| Sodium Chloride | | 1.8 |
| Perfume microcapsules according to | | 3.6 |
| example 1 (expressed as percentage | | |
| of encapsulated perfume oil) | | |

¹Disodium 2,2′-((1,1′-biphenyl)-4,4′-diyldivinylene)bis(benzenesulphonate) (Tinopal ® CBS ex BASF)
²Ethoxylated Polyethyleneimine (Sokalan HP ® 20 ex BASF) ³Polypropylene terephthalate
⁴Vinylpyrrolidon/Vinylimidazol copolymer (PVP/PVI)(Sokalan ® HP 56 ex BASF)

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition of the same term in a document incorporated by reference, the meaning of definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A multi-compartment unit dose article comprising at least a first compartment and a second compartment, wherein the first compartment comprises a solid composition and wherein the second compartment comprises a liquid composition, wherein the solid composition is obtainable by a process comprising the steps of:
a. preparing a base solid composition wherein the base solid composition comprises less than about 5% of water; and
b. adding to the base solid composition from about 0.1% to about 5% of a perfume microcapsules composition, wherein the perfume microcapsules composition comprises from about 20% to about 70% by weight of the perfume microcapsules composition of perfume microcapsules and from about 0.5% to about 5% or from about 15% to about 30%, by weight of the perfume microcapsules composition of water.

2. A multi-compartment unit dose article according to claim 1, wherein the liquid compartment comprises less than about 1%, of structurant.

3. A multi-compartment unit dose article according to claim 1, wherein the weight ratio between the first and second compartment is about 1:1 to about 1:25.

4. A multi-compartment unit dose article according to claim 1, wherein the first and second compartments are arranged in a side-by-side arrangement.

5. A multi-compartment unit dose article according to claim 1, wherein the solid composition also comprises non-encapsulated free perfume material, and wherein the liquid composition comprises less than about 1% of perfume.

6. A multi-compartment unit dose article according to claim 1, wherein the perfume microcapsule comprises a shell.

7. A multi-compartment unit dose article according to claim 6, wherein the shell comprises melamine formaldehyde.

8. A multi-compartment unit dose article according to claim 6, wherein the shell comprises polyurea.

9. A multi-compartment unit dose article according to claim 6, wherein the shell comprises resorcinol.

10. A multi-compartment unit dose article according to claim 6, wherein the shell comprises polyurethane.

11. A multi-compartment unit dose article according to claim 1, wherein the solid composition comprises from about 0.01% to about 10% of a deposition aid.

12. A multi-compartment unit dose article according to claim 1, wherein the perfume microcapsules composition is in the form of an agglomerate or a spray-dried particle, wherein the agglomerate or spray-dried particle comprises water, wherein the microcapsules are comprised within the water.

13. A multi-compartment unit dose article according to claim 1, wherein the perfume microcapsules composition is in the form of an agglomerate or a spray-dried particle, wherein the agglomerate or spray-dried particle comprises a slurry wherein the microcapsules are comprised within the water.

14. A multi-compartment unit dose article according to claim 1, wherein the first and second compositions are fabric treatment compositions.

15. A multi-compartment unit dose article according to claim 14, wherein the first and second compositions are laundry conditioning compositions.

16. A multi-compartment unit dose article according to claim 1, wherein the liquid composition, the solid composition, or a combination thereof comprises a fabric softening ingredient.

17. A multi-compartment unit dose article according to claim 1, wherein the liquid composition, the solid composition, or a combination thereof comprises a chelant.

18. A multi-compartment unit dose article according to claim 17, wherein the solid composition comprises a chelant.

19. A multicompartment unit dose article according to claim 17 wherein the chelant is 1-hydroxyethane 1,1-diphosphonic acid or a salt thereof.

20. A method of laundering comprising the step of placing at least one article according to claim 1 into the washing machine along with the laundry to be washed, and carrying out a washing or cleaning operation.
